(19) United States
(12) Patent Application Publication
(10) Pub. No.: US 2020/0153474 A1
(43) Pub. Date: May 14, 2020

(54) Automatic ceramic ball fine grinding processing equipment

(71) Applicant: Ying Xu, Tianjin City (CN)

(72) Inventor: Ying Xu, Tianjin City (CN)

(21) Appl. No.: 16/744,150

(22) Filed: Jan. 15, 2020

(30) Foreign Application Priority Data
Sep. 6, 2019 (CN) 2019108408863

(51) Int. Cl. H04B 1/3888

(52) U.S. Cl. CPC H04B 1/3888; H04M 1/0202

(57) ABSTRACT

The invention discloses a mobile phone case with self-supporting, and includes a mobile phone case, the mobile phone case is provided with a buffer mechanism. The buffer mechanism includes a trapezoid block, a short groove, a hollow block, a mobile phone slot and three compressed buffer springs. The upper end wall of the mobile phone slot communicates with the outside and is used for storing the mobile phone. The lower end wall of the mobile phone groove is provided with a movable groove whose lower end wall communicates with the outside, and a support mechanism is slidably arranged in the movable groove; the device has a simple structure, is easy to operate, and can be freely adjusted in terms of the placement angle, and the support is in a stable triangle The structure is not easy to break, and when a large force is received, a buffer spring can be ejected, which has a certain protective effect on itself.

### CROSS-REFERENCES TO RELATED APPLICATIONS

The present application claims priority from Chinese application No. 2019103257373 filed on Apr. 22, 2019 which is hereby incorporated by reference in its entirety.

### FIELD OF TECHNOLOGY

The invention relates to the field of mobile accessories, and in particular relates to a mobile phone case with self-supporting.

### TECHNICAL FIELD

The mobile phone case is a kind of accessory that is placed on the outside of the mobile phone. Its main function is to protect the mobile phone and decoration. It also has a mobile phone case with its own support function. Most of the existing mobile phone support functions rely on pulling out a support rod. Force is easily damaged.

Content of the Invention

An object of the present invention is to provide a mobile phone case with a support to solve the problems mentioned in the background art.

In order to achieve the above object, the present invention provides the following technical solution: a mobile phone case with a support, comprising a mobile phone case, the mobile phone case is provided with a buffer mechanism, and the buffer mechanism includes a trapezoid block, a short groove, a hollow block, and a mobile phone The groove is connected to three compressed buffer springs. The upper end wall of the mobile phone groove communicates with the outside for storing the mobile phone. The trapezoidal block is blocked by the short groove. The lower end wall of the mobile phone groove is provided with a movable groove with a lower end wall communicating with the outside. A support mechanism is slidably provided in the movable groove, and the support mechanism includes a short plate, a long plate, a stuck groove, a hook, a thin rod, a restriction groove, a triangle block and a moving block, and the thin rod can promote the movement The block moves upward, so that the triangular block can enter the restriction slot when it moves to the restriction slot, and the hook can be caught by turning the hook, so that the short plate is opposite to the long plate The position remains the same, and when the long plate moves to the right until the triangular block detaches from the uppermost restriction groove, the long plate can push the trapezoidal block out of the short groove, so that the buffer spring returns and drives the Hollow Movement to the outside, the support mechanism can change the angle of the phone housing when the movable sliding slot, such that said movable tank is provided for limiting the spring plate and the shorter the length of the reset plate.

Preferably, the buffer mechanism includes a hollow block, a buffer groove is provided on the lower end face of the mobile phone case, and a movable groove is provided in the left end wall of the buffer groove, and the movable groove and the buffer groove communicate with each other through the short groove. A hollow block is slidingly provided in the buffer groove, a spring groove is provided on the upper end surface of the hollow block, three buffer springs fixed to the upper end wall of the buffer groove are evenly fixed on the lower end wall of the spring groove, and the left end of the hollow block is A pressure groove is arranged on the surface, a pressure spring is fixed on the right end wall of the pressure groove, and a trapezoidal block with a left end in the short groove is fixed on the left end of the pressure spring, and when the trapezoidal block leaves the short groove, The buffer spring is reset and pushes the hollow block out.

Preferably, the supporting mechanism includes a long plate, and the upper end wall of the movable groove is evenly provided with five of the restriction grooves. A movable block is slidably arranged in the movable groove, and an inclined groove is provided on an upper end surface of the movable block. The left end wall of the chute is provided with a moving groove, and the right end wall of the chute is connected with the movable groove through a through groove. A moving block is slidably arranged in the moving groove. The upper end of the moving block is fixed with an upper end and an upper end of the moving groove. A moving spring fixedly connected to the wall, the right end of the moving block is fixed with a moving rod whose right end is located in the chute, the right end of the moving rod is fixed with a moving block, and the upper end of the moving block is provided with an elastic groove, which is elastic. An elastic spring is fixed at the lower end wall of the groove, a triangular block is fixed at the upper end of the elastic spring, and a cylindrical rod is fixed at the lower end of the movable block; wherein, a circular block is rotatably provided on the cylindrical rod, and a short plate whose lower end is located outside is fixed at the lower end of the ring block. A dead block is fixed on the end surface of the short plate, and a dead groove is provided in the dead block. A linkage slot is provided in the short plate, and a square block slidingly connected to the movable slot is provided on the upper side of the movable block. The left end of the square block and the right end of the movable block are fixedly connected by a limit spring. A support rod is fixed on the right end surface of the square block, and an arc-shaped block is rotatably provided on the support rod. A long plate with a lower end located outside is fixed on the lower end of the arc-shaped block. A rotating shaft is rotatably provided on the rear wall of the storage slot, a rotating rod is fixed on the rotating shaft, and a hook is fixed on the upper end of the rotating rod, and the moving block can be pushed up when the thin rod moves to the left.

In summary, the beneficial effects of the present invention are: the device has a simple structure, is easy to operate, and can be freely adjusted in terms of placement angle, and the support has a stable triangular structure, which is not easy to break, and can be popped out when subjected to a large force The spring has a certain protective effect on itself. Brief Description of the Drawings

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

### BRIEF DESCRIPTION OF THE DRAWINGS

The present invention will be described in detail below with reference to FIGS. 1-3. Among them, for convenience of description, the orientation described below is specified as follows: the up-down, left-right, front-back direction described below is consistent with the up-down, left-right, front-back direction of the projection relationship of FIG. 1-3

FIG. 1 is a schematic front view of a mobile phone case with a full support and a cross-section of the present invention;

FIG. 2 is a schematic diagram of an enlarged structure of a movable block in a mobile phone case with a support according to the present invention;

FIG. 3 is a schematic diagram of an enlarged structure of a rotating rod in a mobile phone case with a support according to the present invention.

### DETAILED DESCRIPTION OF THE INVENTION

All features disclosed in this specification, or all disclosed methods or steps, other than mutually exclusive features and/or steps, may be combined in any manner.

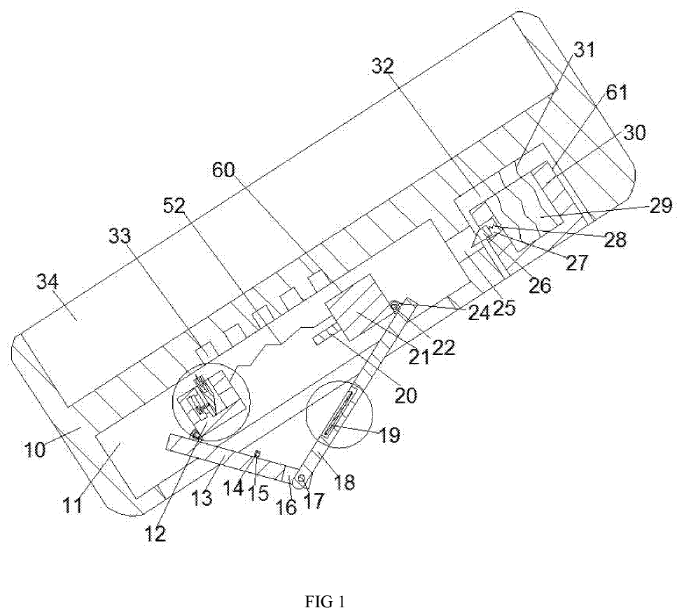

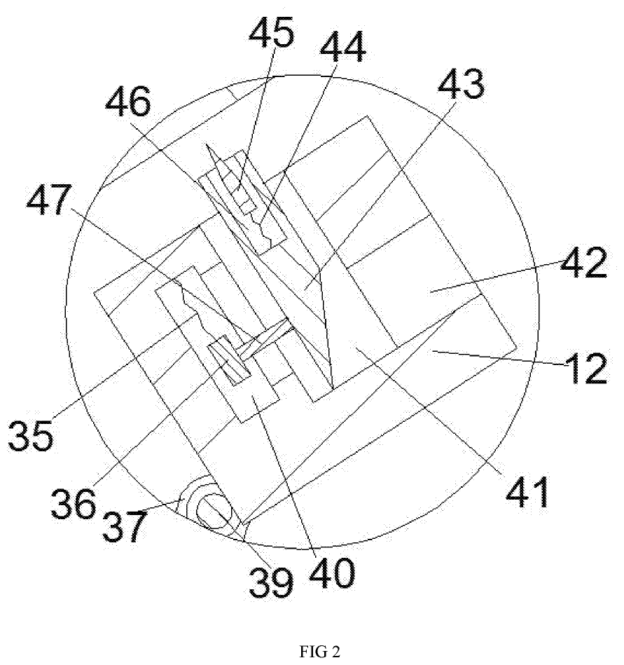

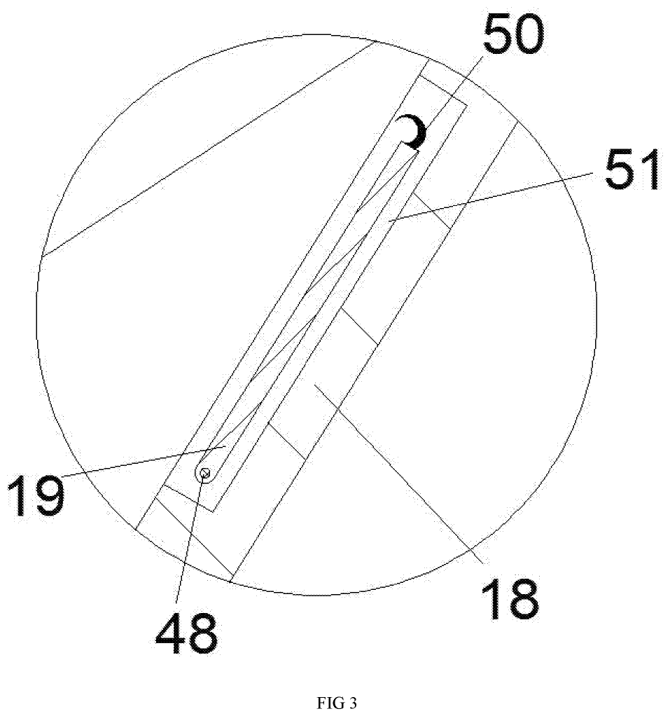

Please refer to FIGS. 1-3. An embodiment of the present invention provides a mobile phone case with a support, which includes a mobile phone case 10. The mobile phone case 10 is provided with a buffer mechanism 61. The buffer mechanism 61 includes a trapezoidal block. 26. Short slot 25, hollow block 30, mobile phone slot 34 and three compressed buffer springs 31. The upper end wall of the mobile phone slot 34 communicates with the outside for storing mobile phones. The trapezoidal block 26 is blocked by the short slot 25. In the lower end wall of the mobile phone slot 34, a movable slot 11 with a lower end wall communicating with the outside is provided, and a support mechanism 60 is slidably arranged in the movable slot 11. The support mechanism 60 includes a short plate 13, a long plate 18, and a stuck groove 14., Hook 50, thin rod 20, restriction groove 33, triangular block 45 and moving block 43, the thin rod 20 can push the moving block 43 to move upward, so that the triangular block 45 moves to the limiting groove 33 Can enter the restriction slot 33 when turning, the hook 50 can be hooked to the blocking slot 14, so that the relative position of the short plate 13 and the long plate 18 remains unchanged, and the long plate 18 is to the right When the triangular block 45 moves away from the uppermost limiting groove 33, the long plate 18 can move the trapezoidal block 26 Out of the short slot 25, the buffer spring 31 is reset, and the hollow block 30 is moved to the outside. The support mechanism 60 can change the angle of the mobile phone case 10 when sliding in the movable slot 11, A limiting spring 52 is provided in the movable groove 11 for resetting the short plate 13 and the long plate 18.

Beneficially, the buffer mechanism 61 includes a hollow block 30, a buffer groove 32 is provided on the lower end surface of the mobile phone case 10, and a movable groove 11 is provided in the left end wall of the buffer groove 32, and the movable groove 11 and the buffer groove 32 is communicated through the short groove 25. A hollow block 30 is slidably provided in the buffer groove 32. A spring groove 29 is provided on the upper end surface of the hollow block 30. Three lower walls of the spring groove 29 are evenly fixed to the three. A buffer spring 31 fixed on the upper end wall of the buffer groove 32 is provided with a pressure groove 27 on the left end surface of the hollow block 30. A pressure spring 28 is fixed on the right end wall of the pressure groove 27. The left end of the pressure spring 28 is fixed on the short end. The trapezoidal block 26 in the groove 25, and when the trapezoidal block 26 is disengaged from the short groove 25, the buffer spring 31 can be reset and push the hollow block 30 out.

Beneficially, the support mechanism 60 includes a long plate 18, and the upper end wall of the movable groove 11 is evenly provided with five of the restriction grooves 33. A movable block 12 is slidably arranged in the movable groove 11, and the movable block 12 is provided on the movable block 12. The end face is provided with a chute 41, a left end wall of the chute 41 is provided with a moving groove 40, a right end wall of the chute 41 is in communication with the movable groove 11 through a through groove 42, and a moving block 36 is slidably provided in the moving groove 40 The upper end of the moving block 36 is fixed with a moving spring 35 whose upper end is fixedly connected to the upper end wall of the moving groove 40. The right end of the moving block 36 is fixed with a moving rod 47 having a right end located in the inclined groove 41. A moving block 43 is fixed at the right end of the rod 47. An elastic groove 46 is provided on the upper end surface of the moving block 43. An elastic spring 44 is fixed to the lower end wall of the elastic groove 46. A triangular block 45 is fixed to the upper end of the elastic spring 44. A cylindrical rod 39 is fixed to the lower end of the block 12; a ring block 37 is rotatably provided on the cylindrical rod 39, and a short plate 13 with a lower end located outside is fixed at the lower end of the ring block 37. A dead groove 14 is provided in 15, a linkage groove 16 is provided in the short plate 13, and a square block 21 slidingly connected to the movable groove 11 is provided on the upper side of the movable block 12, and the left end face of the square block 21 is provided. It is fixedly connected to the right end surface of the movable block 12 by a limit spring 52. A support rod 22 is fixed to the right end surface of the square block 21. An arc-shaped block 24 is rotatably provided on the support rod 22, and the arc-shaped block 24 has a lower end. A long plate 18 having a lower end located outside is fixed, and an upper end surface of the long plate 18 is provided with a storage groove 51. A rear end wall of the storage groove 51 is rotatably provided with a rotation shaft 48, and a rotation rod 19 is fixed on the rotation shaft 48. A hook 50 is fixed at the upper end of the rotating rod 19, and when the thin rod 20 moves to the left, the moving block 43 can be pushed up.

In the following, the applicant will refer to the accompanying drawings 1-3 and the specific composition of a self-supporting mobile phone case of the present application described above to describe in detail the method of using the self-supporting mobile phone case of the present application:

When it is not necessary to support the mobile phone, the limit spring 52 is in a normal state, so that the rear end face of the mobile phone case 10 is horizontal. When support is needed, the short plate 13 and the long plate 18 are pushed so that the thin rod 20 enters the chute 41 and pushes The moving block 43 rises, thereby pushing the triangular block 45 to rise, take out the rotating rod 19, and hook the deadlock slot 14 with the hook 50. At this time, push the short plate 13 to drive the triangular block 45 into different restriction slots 33, thereby The mobile phone case 10 is supported at different angles. When the mobile phone case 10 is under a large pressure, the long plate 18 can be pushed upward, so that the triangular block 45 is separated from the uppermost limiting groove 33, and the long plate 18 moves the trapezoidal block 26 from the short groove. It is pushed out in 25, so that the buffer spring 31 is reset, and the hollow block 30 is ejected, which plays a certain buffering effect on the mobile phone case 10.

The beneficial effects of the present invention are: the device has a simple structure, is easy to operate, and can be freely adjusted in terms of placement angle, and the support has a stable triangular structure, which is not easy to break, and when subjected to a large force, a buffer spring can be ejected. It has a certain protective effect.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A mobile phone case with self-supporting, including a mobile phone case, is characterized in that the mobile phone case is provided with a buffer mechanism, and the buffer mechanism includes a trapezoidal block, a short groove, a hollow block, a mobile phone slot and three quilts. A compressed buffer spring, the upper end wall of the cell phone slot communicates with the outside world for storing the cell phone, the trapezoidal block is blocked by the short slot, and a lower end wall of the cell phone groove is provided with a movable slot that communicates with the outside world. A support mechanism is slidably arranged in the groove. The support mechanism includes a short plate, a long plate, a stuck groove, a hook, a thin rod, a restriction groove, a triangular block and a moving block. The thin rod can push the moving block to move upward. Therefore, when the triangular block moves to the restriction slot, the triangle block can enter the restriction slot, and the hook can be caught by turning the hook, so that the relative position of the short plate and the long plate remains unchanged, when the long plate moves to the right until the triangular block detaches from the uppermost restriction groove, the long plate can push the trapezoidal block out of the short slot, so that the buffer spring is reset, and the hollow block is moved to outside, said When the supporting mechanism slides in the movable groove, the angle of the mobile phone shell can be changed, and a limiting spring for resetting the short plate and the long plate is provided in the movable groove.

2. The mobile phone case with self-supporting according to claim 1, wherein the buffer mechanism comprises a hollow block, a buffer groove is provided on the lower end surface of the mobile phone case, and a movable groove is provided in the left end wall of the buffer groove The movable groove is in communication with the buffer groove through the short groove; a hollow block is slidably arranged in the buffer groove, a spring groove is provided on the upper end surface of the hollow block, and three are evenly fixed on the lower end wall of the spring groove; a buffer spring fixed to the upper end wall of the buffer groove, a pressure groove is provided on the left end surface of the hollow block, a pressure spring is fixed to the right end wall of the pressure groove, and a trapezoid with a left end located in the short groove is fixed to the left end of the pressure spring. Moreover, when the trapezoidal block is disengaged from the short groove, the buffer spring can reset and push the hollow block out.

3. The mobile phone case with self-supporting according to claim 1, wherein the supporting mechanism comprises a long plate, and the upper end wall of the movable groove is evenly provided with five of the restriction grooves, and the movable groove slides in the movable groove; a movable block is provided, an upper end of the movable block is provided with a diagonal groove, a left end wall of the inclined groove is provided with a moving groove, a right end wall of the inclined groove is communicated with the movable groove through a through groove, and a sliding groove is provided in the moving groove; a moving block, a moving spring having an upper end fixedly connected to an upper end wall of the moving groove is fixed at an upper end of the moving block, a moving rod having a right end located in the inclined groove is fixed at a right end of the moving block, and a right end of the moving rod is fixed a moving block, an elastic groove is provided on the upper end surface of the moving block, an elastic spring is fixed on the lower end wall of the elastic groove, a triangular block is fixed on the upper end of the elastic spring, and a cylindrical rod is fixed on the lower end of the movable block; wherein, a circular block is rotatably provided on the cylindrical rod, and a short plate whose lower end is located outside is fixed at the lower end of the ring block; a dead block is fixed on the end surface of the short plate, and a dead groove is provided in the dead block; a linkage slot is provided in the short plate, and a square block slidingly connected to the movable slot is provided on the upper side of the movable block; the left end of the square block and the right end of the movable block are fixedly connected by a limit spring; a support rod is fixed on the right end surface of the square block, and an arc-shaped block is rotatably provided on the support rod; a long plate with a lower end located outside is fixed on the lower end of the arc-shaped block; a rotating shaft is rotatably provided on the rear wall of the storage slot, a rotating rod is fixed on the rotating shaft, and a hook is fixed on the upper end of the rotating rod, and the moving block can be pushed up when the thin rod moves to the left.
